(19) United States
(12) Patent Application Publication
(10) Pub. No.: US 2026/0295614 A1
(43) Pub. Date: Oct. 1, 2026

(54) BACKPACK TYPE WORKING MACHINE

(71) Applicant: MAKITA CORPORATION, Anjo-shi (JP)

(72) Inventors: Toshihiro TOMITA, Anjo-shi (JP); Masahiro ITO, Anjo-shi (JP)

(73) Assignee: MAKITA CORPORATION, Anjo-shi (JP)

(21) Appl. No.: 19/577,635

(22) Filed: Mar. 25, 2026

(30) Foreign Application Priority Data
Mar. 27, 2025 (JP) 2025-054244

(51) Int. Cl. B05B 9/08; A45F 3/08; A45F 3/00; A45F 3/04

(52) U.S. Cl. CPC B05B 9/0888; A45F 3/08; A45F 2003/003; A45F 2003/045; B05B 9/085

(57) ABSTRACT

A backpack type working machine may include a body unit, a motor housed in the body unit, a shoulder belt attached to the body unit and configured to be worn on a shoulder of a user, an operation unit configured to be used to switch a state of the motor, and a first attachment portion configured to attach the operation unit to the shoulder belt. A position of the operation unit on the shoulder belt may be configured adjustable.

### CROSS REFERENCE TO RELATED APPLICATION(S)

This application claims priority to Japanese Patent Application No. 2025-054244 filed on Mar. 27, 2025. The entire content of the priority application is incorporated herein by reference.

### TECHNICAL FIELD

The art disclosed herein relates to a backpack type working machine.

### BACKGROUND ART

Japanese Patent Application Publication No. 2014-54224 describes a backpack-type working machine including a body unit, a motor housed in the body unit, a shoulder belt attached to the body unit and configured to be worn on a shoulder of a user, and an operation unit for switching a state of the motor. In this working machine, the operation unit for switching the state of the motor is installed in the body unit.

### SUMMARY

The present teachings provide an art which allows to improve convenience for a user using a backpack type working machine.

The present teachings disclose a backpack type working machine. The backpack type working machine may comprise: a body unit; a motor housed in the body unit; a shoulder belt attached to the body unit and configured to be worn on a shoulder of a user; an operation unit configured to be used to switch a state of the motor; and a first attachment portion configured to attach the operation unit to the shoulder belt. A position of the operation unit on the shoulder belt may be configured adjustable.

When an operation unit is disposed on a body unit, as in the backpack type working machine of JP-A-2014-54224, the user needs to operate the operation unit by putting his/her hand behind the user's body while carrying the backpack type working machine on his/her back. Therefore, the user could feel difficulty in operating the operation unit. In the above configuration, the operation unit can be attached to the shoulder belt. In addition, the user can adjust the position of the operation unit on the shoulder belt to a position that is easy for the user to operate. Thus, the user can easily operate the operation unit on the front side of the user's body. Thus, convenience for the user using the backpack type working machine can be improved.

Further, the present teachings disclose another backpack type working machine. The backpack type working machine may comprise: a body unit; a motor housed in the body unit; a shoulder belt attached to the body unit and configured to be worn on a shoulder of a user; a display unit configured to display information related to an output of the motor; and an attachment portion configured to attach the display unit to the shoulder belt. A position of the display unit on the shoulder belt may be configured adjustable.

It is desirable for the user to be able to see information related to the output of the motor when using the backpack type working machine. In the above configuration, the display unit can be attached to the shoulder belt and the position of the display unit on the shoulder belt is configured adjustable. This allows the user to position the display unit on the front side of the user's body. The user can also adjust the position of the display unit on the shoulder belt to a position that is easily visible to the user. Thus, the user can see information related to the output of the motor when using the backpack type working machine. Thus, convenience for the user using the backpack type working machine can be improved.

### BRIEF DESCRIPTION OF DRAWINGS

FIG. 1 is a perspective view of a sprayer 2 of the first embodiment, seen from a front, upper right side.

FIG. 2 shows a control configuration of the sprayer 2 of the first embodiment.

FIG. 3 is a front view of the sprayer 2 of the first embodiment.

FIG. 4 is a rear view of the sprayer 2 of the first embodiment.

FIG. 5 is a front view of the sprayer 2 of the first embodiment with an operation unit 10 removed.

FIG. 6 is a perspective view of a right triglide 86 in the first embodiment.

FIG. 7 is a right cross-sectional view of the right triglide 86 and its surroundings with the operation unit 10 removed in the first embodiment.

FIG. 8 is a perspective view of a left triglide 116 in the first embodiment.

FIG. 9 is a right view of a switch unit 160 of the first embodiment.

FIG. 10 is a front view of the switch unit 160 of the first embodiment.

FIG. 11 is a right cross-sectional view of the right triglide 86 and its surroundings with the switch unit 160 attached in the first embodiment.

FIG. 12 is a right view of the sprayer 2 with the switch unit 160 attached in front of a user's shoulder in the first embodiment.

FIG. 13 is a front view of a display unit 260 of the second embodiment.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved backpack type working machines.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a backpack type working machine may comprise: a body unit; a motor housed in the body unit; a shoulder belt attached to the body unit and configured to be worn on a shoulder of a user; an operation unit configured to be used to switch a state of the motor; and a first attachment portion configured to attach the operation unit to the shoulder belt. A position of the operation unit on the shoulder belt may be configured adjustable.

In one or more embodiments, the first attachment portion may be configured movable on the shoulder belt. A maximum static friction force between the first attachment portion and the shoulder belt under a state where the operation unit is attached to the first attachment portion may be larger than a maximum static friction force between the first attachment portion and the shoulder belt under a state where the operation unit is not attached to the first attachment portion.

When a user is operating the operation unit attached to the shoulder belt, it is undesirable for the operation unit on the shoulder belt to be displaced. According to the above configuration, the position of the operation unit on the shoulder belt can be suppressed from being displaced when the user is operating the operation unit attached to the shoulder belt.

In one or more embodiments, the operation unit may comprise: a first operation portion disposed along a first plane including a first direction and a second direction perpendicular to the first direction; and a second operation portion connected to an end in the first direction of the first operation portion and disposed along a second plane including a third direction and the second direction, the third direction being a direction inclined relative to the first direction. When the operation unit is seen along the second direction, an angle between a back surface of the first operation portion and a back surface of the second operation portion may be an obtuse angle.

According to the above configuration, when the operation unit is attached to the shoulder belt in proximity to the user's shoulder, the operation unit can be positioned along the user's shoulder.

In one or more embodiments, under the state where the operation unit is attached to the first attachment portion, the first operation portion may be disposed above the second operation portion. A display may be disposed on a front surface side of the first operation portion. A dial-type switch that protrudes from a front surface of the second operation portion may be disposed on the front surface side of the second operation portion.

If the dial-type switch is arranged in the first operation portion and the display is arranged in the second operation portion, the dial-type switch obstructs the view of the display, making it difficult to see. According to the above configuration, the dial-type switch does not obstruct the user’s view of the display. Therefore, visibility of the display can be improved.

In one or more embodiments, the dial-type switch may be a switch configured to be used to change an output of the motor. Information displayed on the display may include information that changes according to an operation performed by the user on the dial-type switch.

According to the above configuration, the user can operate the dial-type switch while looking at the information that changes according to the operation performed on the dial-type switch. Therefore, user convenience can be improved.

In one or more embodiments, the backpack type working machine may comprise: a waist belt attached to the body unit and configured to be worn on a waist of the user; and a second attachment portion configured to attach the operation unit to the waist belt.

According to the above configuration, the user can also attach the operation unit to the waist belt. Therefore, the user convenience can further be improved.

In one or more embodiments, a backpack type working machine may comprise: a body unit; a motor housed in the body unit; a shoulder belt attached to the body unit and configured to be worn on a shoulder of a user; a display unit configured to display information related to an output of the motor; and an attachment portion configured to attach the display unit to the shoulder belt. A position of the display unit on the shoulder belt may be configured adjustable.

In one or more embodiments, the working machine may be a sprayer. The information related to the output of the motor may be a spray pressure.

In sprayers, a spray pressure is important. According to the above configuration, the user can easily check the spray pressure, which is important information.

### First Embodiment

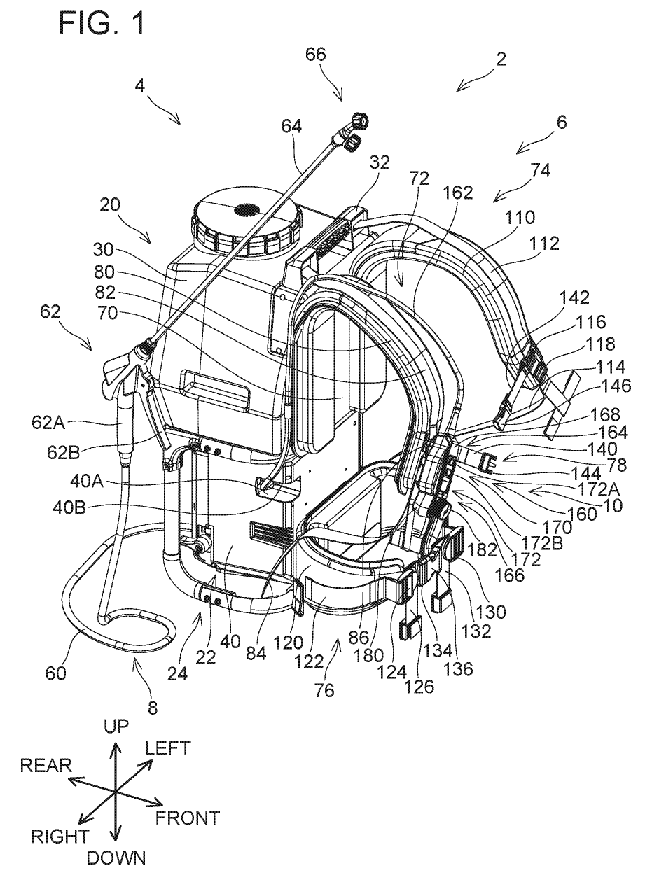

As shown in FIG. 1, a backpack type sprayer 2 comprises a body unit 4, a backpack unit 6, a nozzle unit 8, and an operation unit 10. The sprayer 2 is a device configured to spray a liquid such as a chemical solution. In the following, a front-rear direction, a left-right direction, and an up-down direction of the sprayer 2 when an operator stands upright with the sprayer 2 on his/her back, as seen from the operator's perspective will be referred to as the front-rear direction, left-right direction, and up-down direction of the sprayer 2.

The body unit 4 comprises a tank unit 20, a work unit 22, and a frame unit 24. The tank unit 20 comprises a tank 30 and a shoulder belt attachment portion 32 attached to an upper front part of the tank 30. The tank 30 stores liquid such as a chemical solution.

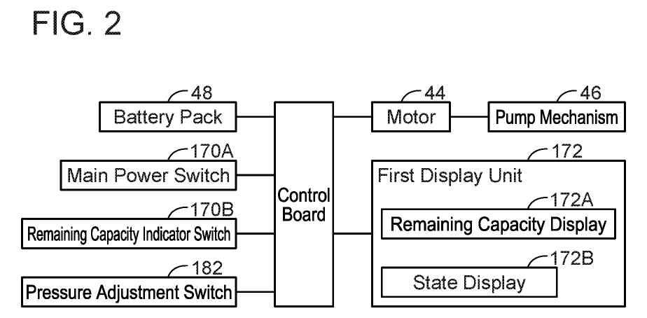

The work unit 22 comprises a housing 40, a control board 42 (see FIG. 2), a motor 44 (see FIG. 2), a pump mechanism 46 (see FIG. 2), and a battery pack 48 (see FIG. 2). The tank 30 is attached to an upper part of the housing 40.

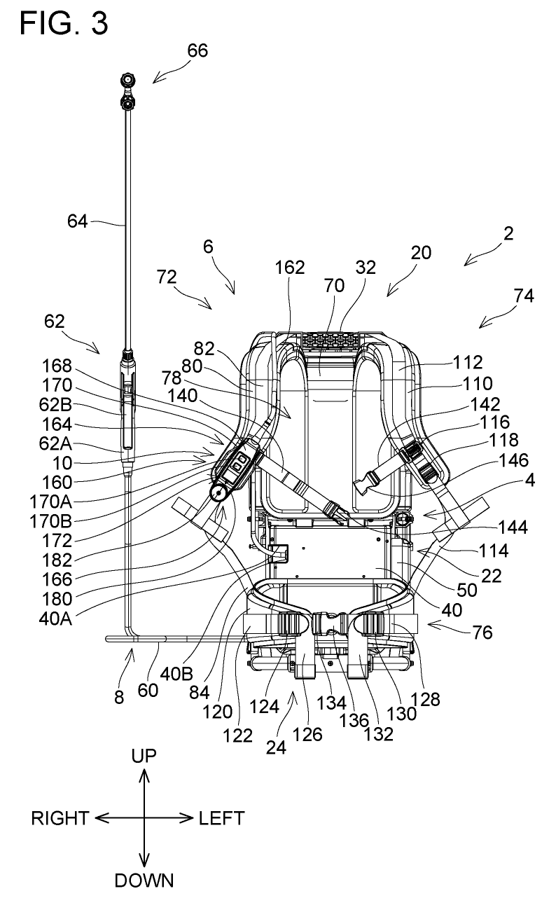

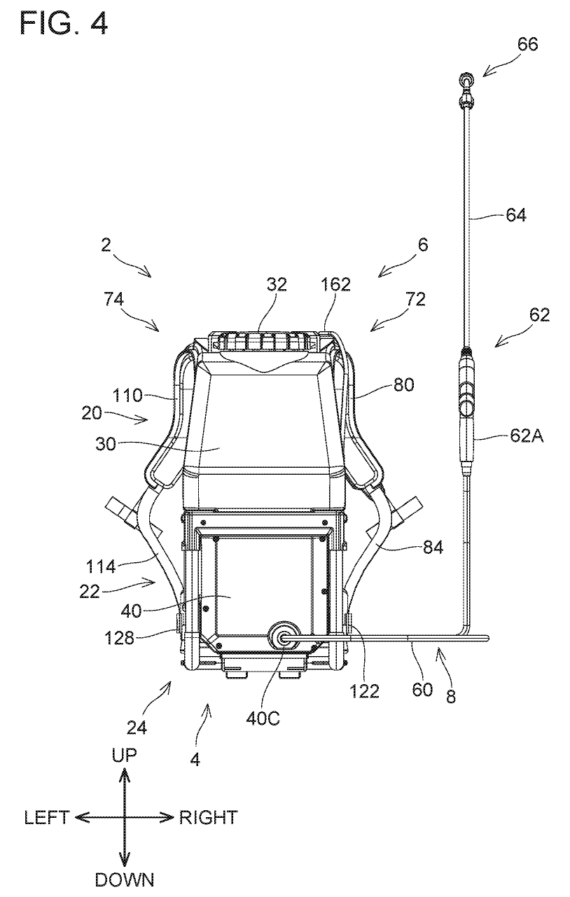

The housing 40 houses the control board 42, the motor 44, the pump mechanism 46, and the battery pack 48 (see FIG. 2). Although this is an example, the battery pack 48 in FIG. 2 is a rechargeable battery such as a lithium-ion battery. The battery pack 48 supplies electric power to the motor 44. The pump mechanism 46 is driven in response to the motor 44 being driven. As shown in FIG. 3, a battery cover 50 configured to be opened and closed is disposed on the left surface of the housing 40. A battery attachment portion where the battery pack 48 (see FIG. 2) can be attached or detached is disposed inside the battery cover 50. A cable hole 40B is defined in a recessed portion 40A on the right surface of the housing 40. The cable hole 40B is located below the center of the body unit 4 in the up-down direction. The cable hole 40B is disposed above a waist pad 120 of a waist belt 76, which will be described later. As shown in FIG. 4, a water outlet 40C is defined at a lower part of the rear surface of the housing 40.

The nozzle unit 8 comprises a hose 60, a grip unit 62, a spray tube 64, and a nozzle head 66. One end of the hose 60 is connected to the water outlet 40C of the housing 40. The other end of the hose 60 is connected to the grip unit 62. One end of the spray tube 64 is connected to the grip unit 62. The other end of the spray tube 64 is connected to the nozzle head 66. The grip unit 62 is detachably attached to the hose 60. As shown in FIG. 1, the grip unit 62 comprises a grip portion 62A that is grasped by the user and a lever 62B that is operated by the finger(s) of the user's hand grasping the grip portion 62A. When the lever 62B is pulled while the motor 44 (see FIG. 2) is running, pressurized liquid is sprayed from the nozzle head 66.

The backpack unit 6 comprises a back plate 70, a right shoulder belt 72, a left shoulder belt 74, the waist belt 76, and a chest belt 78. The back plate 70 has a flat plate shape extending in the up-down and left-right directions. The back plate 70 faces the user's back when the user is carrying the backpack unit 6 on his/her back. The shoulder belt attachment portion 32 of the tank unit 20 is attached to the rear surface of an upper part of the back plate 70.

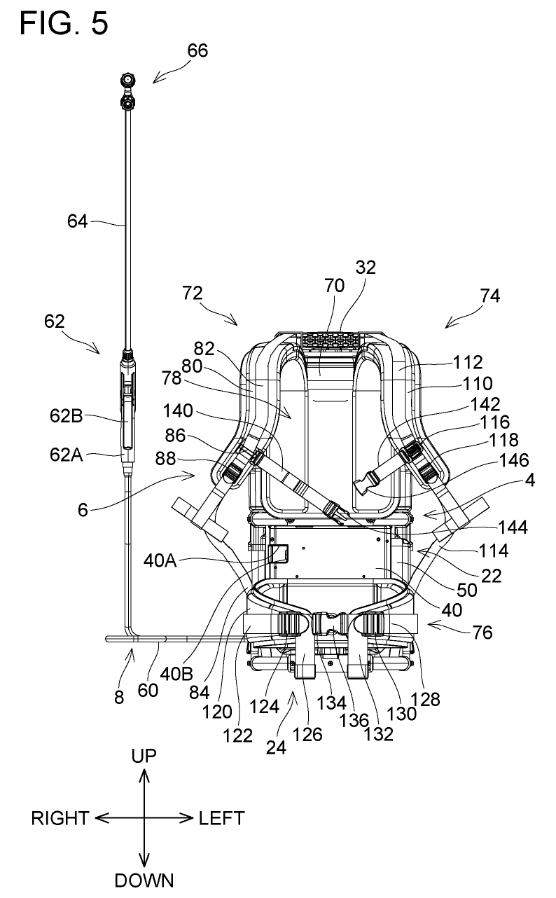

The right shoulder belt 72 and the left shoulder belt 74 are worn on the user's shoulders. As shown in FIG. 5, the right shoulder belt 72 comprises a right shoulder pad 80, a first belt 82, a second belt 84, a right triglide 86, and a first right buckle 88. The right shoulder pad 80 contacts the rear, upper, and front surfaces of the user's right shoulder. The first right buckle 88 is attached to the front surface of the lower end of the right shoulder pad 80. One end of the first belt 82 is connected to the shoulder belt attachment portion 32 of the tank unit 20. The other end of the first belt 82 is connected to the first right buckle 88. The first belt 82 extends along the right shoulder pad 80 between the shoulder belt attachment portion 32 and the first right buckle 88. One end of the second belt 84 is connected to the first right buckle 88. The other end of the second belt 84 is connected to the frame unit 24.

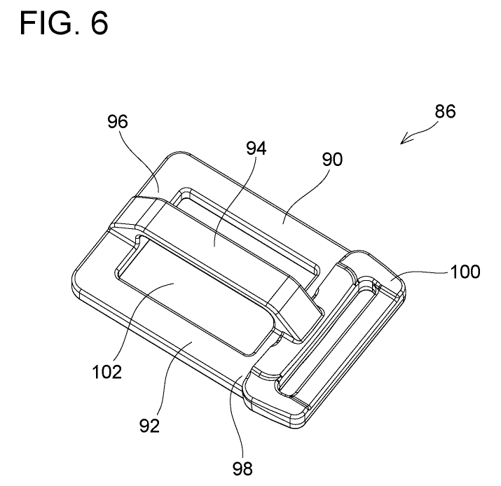

As shown in FIG. 6, the right triglide 86 comprises a first beam portion 90, a second beam portion 92, a third beam portion 94, a first connecting portion 96, a second connecting portion 98, a first belt connecting portion 100, and an opening 102. The first beam portion 90, the second beam portion 92, and the third beam portion 94 are substantially parallel to each other and extend along a longitudinal direction of the right triglide 86. The third beam portion 94 is disposed between the first beam portion 90 and the second beam portion 92. The first connecting portion 96 and the second connecting portion 98 extend along a short direction of the right triglide 86. The first connecting portion 96 connects one end of the first beam portion 90, one end of the second beam portion 92, and one end of the third beam portion 94. The second connecting portion 98 connects the other end of the first beam portion 90, the other end of the second beam portion 92, and the other end of the third beam portion 94. The back surface of the first beam portion 90, the back surface of the second beam portion 92, the back surface of the first connecting portion 96, and the back surface of the second connecting portion 98 are arranged on the substantially same plane. The first beam portion 90, the second beam portion 92, the first connecting portion 96, and the second connecting portion 98 define the opening 102. The third beam portion 94 protrudes toward the front surface of the right triglide 86 relative to the first beam portion 90 and the second beam portion 92. The third beam portion 94 is positioned on the front surface side of the right triglide 86 from the opening 102. The first belt connecting portion 100 is connected to the second connecting portion 98.

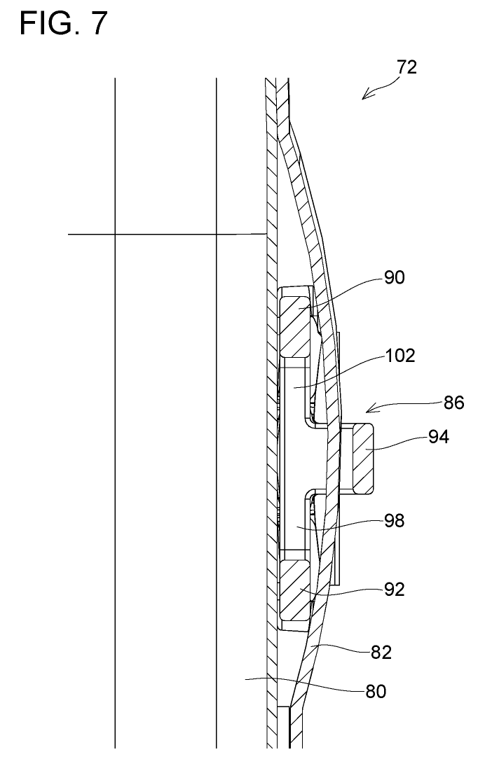

As shown in FIG. 7, under a state where the operation unit 10 is not attached to the right triglide 86, the right triglide 86 is not pressed against the right shoulder pad 80 of the right shoulder belt 72.

Due to this, the right triglide 86 is configured movable along the first belt 82 on the right shoulder belt 72 (and on the right shoulder pad 80 in particular).

As shown in FIG. 5, the left shoulder belt 74 comprises a left shoulder pad 110, a third belt 112, a fourth belt 114, a left triglide 116, and a first left buckle 118. The left shoulder pad 110 contacts the rear, upper, and front surfaces of the user's left shoulder. The first left buckle 118 is attached to the front surface of the lower end of the left shoulder pad 110. One end of the third belt 112 is connected to the shoulder belt attachment portion 32 of the tank unit 20. The other end of the third belt 112 is connected to the first left buckle 118. The third belt 112 extends along the left shoulder pad 110 between the shoulder belt attachment portion 32 and the first left buckle 118. One end of the fourth belt 114 is connected to the first left buckle 118. The other end of the fourth belt 114 is connected to the waist belt 76. The left triglide 116 is attached to the third belt 112 such that the left triglide 116 can move along the third belt 112 on the left shoulder belt 74 (on the left shoulder pad 110 in particular).

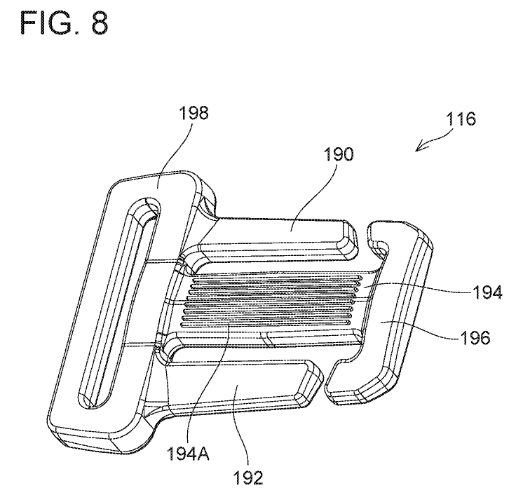

As shown in FIG. 8, the left triglide 116 comprises a fourth beam portion 190, a fifth beam portion 192, a sixth beam portion 194, a seventh beam portion 196, and a second belt connecting portion 198. The fourth beam portion 190, the fifth beam portion 192, and the sixth beam portion 194 extend substantially parallel to each other and along a longitudinal direction of the left triglide 116. The sixth beam portion 194 is disposed between the fourth beam portion 190 and the fifth beam portion 192. The front surface of the sixth beam portion 194 comprises a plurality of protruding portions 194A extending along the longitudinal direction of the left triglide 116. The plurality of protruding portions 194A is arranged along a short direction of the left triglide 116. The plurality of protruding portions 194A functions as a slip stop for the third belt 112. The seventh beam portion 196 and the second belt connecting portion 198 extend along the short direction of the left triglide 116. The second belt connecting portion 198 connects one end of the fourth beam portion 190, one end of the fifth beam portion 192, and one end of the sixth beam portion 194. The other end of the sixth beam portion 194 is connected to the seventh beam portion 196. In the longitudinal direction of the left triglide 116, a gap is defined between the other end of the fourth beam portion 190 and the seventh beam portion 196, and between the other end of the fifth beam portion 192 and the seventh beam portion 196.

The waist belt 76 comprises the waist pad 120, a fifth belt 122, a second right buckle 124, a sixth belt 126, a seventh belt 128, a second left buckle 130, an eighth belt 132, a first male buckle 134, and a first female buckle 136. The first male buckle 134 engages the first female buckle 136. The waist pad 120 is attached to the housing 40 of the work unit 22. The waist pad 120 contacts the rear, right, left, and front surfaces of the user's waist.

As shown in FIG. 1, one end of the fifth belt 122 is fixed to the front surface of a right part of the waist pad 120. The other end of the fifth belt 122 is connected to the second right buckle 124. A portion of the fifth belt 122 that is on a one end side by a slight offset from the other end thereof is secured to the surface of the waist pad 120. The sixth belt 126 is connected to the second right buckle 124 and the first male buckle 134.

As shown in FIG. 5, one end of the seventh belt 128 is secured to the surface of the left part of the waist pad 120. The other end of the seventh belt 128 is connected to the second left buckle 130. A portion of the seventh belt 128 that is on a one end side by a slight offset from the other end thereof is secured to the front surface of the waist pad 120. The eighth belt 132 is connected to the second left buckle 130 and the first female buckle 136.

The chest belt 78 comprises a ninth belt 140, a tenth belt 142, a second male buckle 144, and a second female buckle 146. The second male buckle 144 engages the second female buckle 146. One end of the ninth belt 140 is connected to the first belt connecting portion 100 of the right triglide 86. The other end of the ninth belt 140 is connected to the second male buckle 144. One end of the tenth belt 142 is connected to the second belt connecting portion 198 of the left triglide 116. The other end of the tenth belt 142 is connected to the second female buckle 146.

As shown in FIG. 1, the operation unit 10 comprises a switch unit 160 and a wiring cable 162. One end of the wiring cable 162 is connected to the switch unit 160. The other end of the wiring cable 162 is connected to the cable hole 40B in the housing 40. The wiring cable 162 is electrically connected to the control board 42 (see FIG. 2).

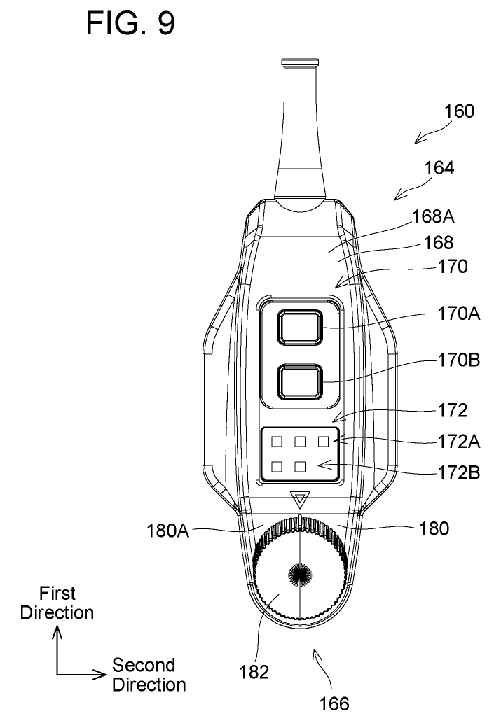

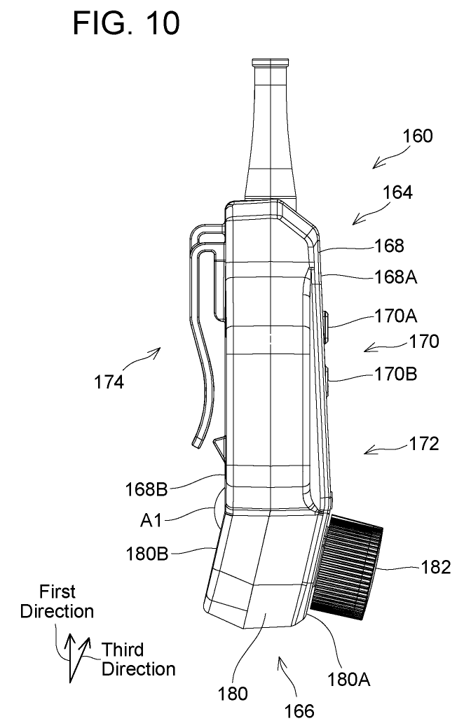

Referring to FIGS. 9 and 10, the switch unit 160 will be described. As shown in FIG. 9, the switch unit 160 comprises an upper operation portion 164 and a lower operation portion 166. The upper operation portion 164 comprises an upper housing 168, a first switch portion 170, a first display 172, and a hook 174 (see FIG. 10). The upper housing 168 extends along a plane including a first direction and a second direction perpendicular to the first direction. The upper housing 168 has a longitudinal direction in the first direction. In FIG. 9, the first direction is parallel to the up-down direction of the drawing and the second direction is parallel to the left-right direction of the drawing. The first switch portion 170 and the first display 172 are disposed on a first front surface 168A side of the upper housing 168. The first front surface 168A is the front surface of the switch unit 160 under a state where the switch unit 160 is attached to the right triglide 86 (see FIG. 1). The first switch portion 170 includes a button-type main power switch 170A and a button-type remaining capacity indicator switch 170B. The main power switch 170A and the remaining capacity indicator switch 170B are arranged along the up-down direction. The first display 172 includes a remaining capacity display 172A and a state display 172B. The remaining capacity display 172A is located above the state display 172B. The remaining capacity display 172A includes a plurality of indicators that display the remaining capacity of the battery pack 48 (see FIG. 2). The state display 172B includes an indicator indicating that there is an abnormality in the sprayer 2 and an indicator indicating that the amount of liquid stored in the tank 30 is at or below a predetermined amount. As shown in FIG. 10, the hook 174 is disposed on a first back surface 168B side of the upper housing 168. The first back surface 168B is the rear surface of the switch unit 160 under a state where the switch unit 160 is attached to the right triglide 86. The hook 174 extends leftward from the first back surface 168B in the drawing, then bends to extend along the downward direction in the drawing, and then curves to extend downward. The curved shape of the hook 174 is a shape that protrudes rightward in the drawing (toward the first front surface 168A of the upper housing 168).

The lower operation portion 166 comprises a lower housing 180 and a dial-type pressure adjustment switch 182. The lower housing 180 extends along a plane including a third direction and a second direction. The third direction is inclined with respect to the first direction. Specifically, the third direction is inclined with respect to the first direction such that an angle A1 between the first back surface 168B of the upper housing 168 and the second back surface 180B of the lower housing 180 is an obtuse angle. Although this is an example, the angle A1 is between 160° and 170°. The pressure adjustment switch 182 protrudes from a second front surface 180A of the lower housing 180. The pressure adjustment switch 182 is a switch configured to be used to adjust the spray pressure of the sprayer 2 according to a rotating operation performed by the user.

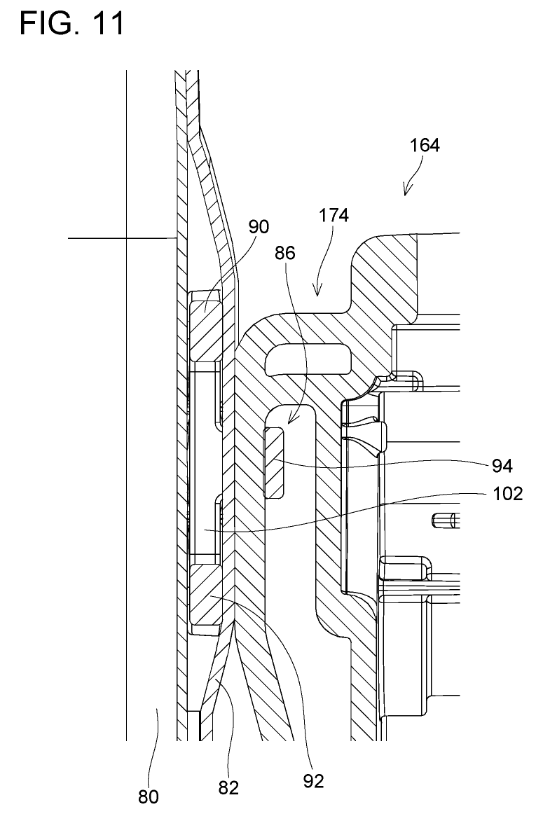

As shown in FIG. 11, the hook 174 of the switch unit 160 can be hooked onto the third beam portion 94 of the right triglide 86. This allows the switch unit 160 to be attached to the right triglide 86. Under the state where the switch unit 160 is attached to the right triglide 86, the first belt 82 is held between the hook 174 and the right triglide 86 (the first beam portion 90 and the second beam portion 92 in particular). This determines the position of the right triglide 86 on the right shoulder belt 72. As a result, the maximum static friction force between the right triglide 86 and the right shoulder belt 72 (or the first belt 82 in particular) is increased. Therefore, the position of the right triglide 86 and the switch unit 160 on the right shoulder belt 72 can be suppressed from being displaced when the user is operating the switch unit 160. Here, once the switch unit 160 has been removed from the right triglide 86 by the user, the right triglide 86 can move again on the right shoulder belt 72 (on the right shoulder pad 80 in particular).

The hook 174 of the switch unit 160 can also be hooked onto the fifth belt 122 (see FIG. 3) of the waist belt 76, the seventh belt 128 (see FIG. 3) of the waist belt 76, the ninth belt 140 (see FIG. 3) of the chest belt 78, and the tenth belt 142 (see FIG. 3) of the chest belt 78. That is, the switch unit 160 can be attached to the waist belt 76 and the chest belt 78 as well.

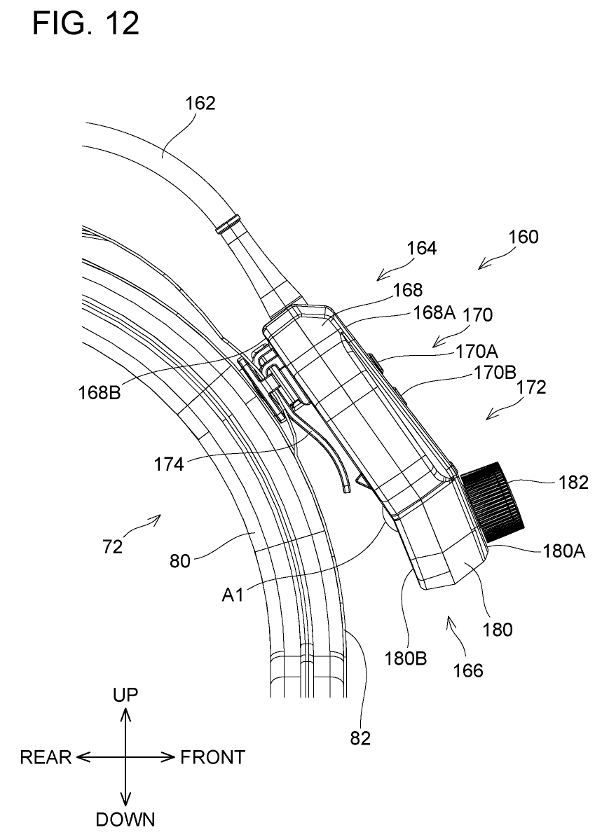

The switch unit 160 can also be attached near the user's shoulder, as shown in FIG. 12. Since the lower housing 180 is inclined with respect to the upper housing 168, the switch unit 160 can be conformed with the user's shoulder when the switch unit 160 is attached near the user's shoulder.

In one or more embodiments, the sprayer 2 (an example of “backpack type working machine”) comprises the body unit 4, the motor 44 housed in the body unit 4, the right shoulder belt 72 (an example of “shoulder belt”) attached to the body unit 4 and configured to be worn on a shoulder of a user, the operation unit 10 configured to be used to switch the state of the motor 44, and the right triglide 86 (an example of “first attachment portion”) configured to attach the operation unit 10 to the right shoulder belt 72. The position of the operation unit 10 on the right shoulder belt 72 is configured adjustable.

If an operation unit is disposed on the body unit 4, the user needs to operate the operation unit by putting his/her hand behind the user's body while carrying the backpack type sprayer 2 on his/her back. Therefore, the user could feel difficulty in operating the operation unit. In the above configuration, the operation unit 10 can be attached to the right shoulder belt 72. The user can adjust the position of the operation unit 10 on the right shoulder belt 72 to a position that is easy for the user to operate. Thus, the user can easily operate the operation unit 10 on the front side of the user's body. Thus, convenience for the user using the backpack type sprayer 2 can be improved.

In one or more embodiments, the right triglide 86 is configured movable on the right shoulder belt 72. The maximum static friction force between the right triglide 86 and the right shoulder belt 72 under the state where the operation unit 10 is attached to the right triglide 86 is larger than the maximum static friction force between the right triglide 86 and the right shoulder belt 72 under the state where the operation unit 10 is not attached to the right triglide 86.

When a user is operating the operation unit 10 attached to the right shoulder belt 72, it is undesirable for the operation unit 10 on the right shoulder belt 72 to be displaced. According to the above configuration, the position of the operation unit 10 on the right shoulder belt 72 can be suppressed from being displaced when the user is operating the operation unit 10 attached to the right shoulder belt 72.

In one or more embodiments, the operation unit 10 comprises the upper operation portion 164 (an example of “first operation portion”) disposed along the first plane that includes the first direction and the second direction perpendicular to the first direction, and the lower operation portion 166 (an example of “second operation portion”) connected to the end in the first direction of the upper operation portion 164 and disposed along the second plane including the third direction and the second direction, the third direction being a direction inclined relative to the first direction. When the operation unit 10 is seen along the second direction, the angle between the first back surface 168B of the upper operation portion 164 and the second back surface 180B of the lower operation portion 166 is an obtuse angle.

According to the above configuration, when the operation unit 10 is attached to the right shoulder belt 72 in proximity to a user's shoulder, the operation unit 10 can be positioned along the user's shoulder.

In one or more embodiments, under the state where the operation unit 10 is attached to the right triglide 86, the upper operation portion 164 is positioned above the lower operation portion 166. The first display 172 (an example of “display”) is disposed on the first front surface 168A side of the upper operation portion 164. The dial-type pressure adjustment switch 182 (an example of “switch”) that protrudes from the second front surface 180A of the lower operation portion 166 is disposed on the second front surface 180A side of the lower operation portion 166.

If the dial-type pressure adjustment switch 182 is arranged in the upper operation portion 164 and the first display 172 is arranged in the lower operation portion 166, the pressure adjustment switch 182 obstructs the view of the first display 172, making it difficult to see. According to the above configuration, the pressure adjustment switch 182 does not obstruct the user’s view of the first display 172. Thus, the visibility of the first display 172 can be improved.

In one or more embodiments, the backpack type sprayer 2 comprises the waist belt 76 attached to the body unit 4 and configured to be worn around the waist of the user, and the fifth belt 122 and the seventh belt 128 (an example of “second attachment portion”) configured to attach the operation unit 10 to the waist belt 76.

According to the above configuration, the user can also attach the operation unit 10 to the waist belt 76. Thus, the user convenience can further be improved.

### Second Embodiment

A sprayer according to the second embodiment will be described below. The sprayer of the second embodiment comprises a display unit 260 instead of the switch unit 160 of the first embodiment. The same symbols will be used for the common components among the embodiments, and descriptions thereof will be omitted.

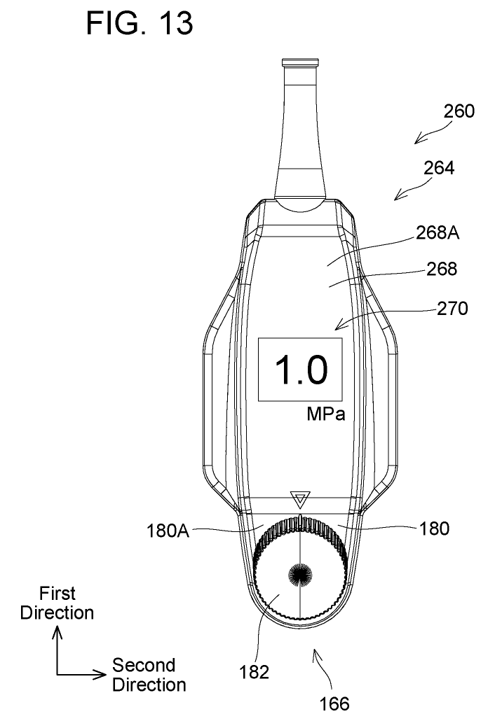

As shown in FIG. 13, the display unit 260 has an upper display 264 and a lower operation portion 166. The upper display 264 comprises an upper housing 268, a pressure display 270, and a hook 174 (see FIG. 10). The shape of the upper housing 268 is the same as that of the upper housing 168 in the first embodiment. The pressure display 270 is disposed on a third front surface 268A side of the upper housing 268. The pressure display 270 numerically indicates the spray pressure. The spray pressure displayed on the pressure display 270 changes according to a rotating operation performed by the user on the pressure adjustment switch 182.

In one or more embodiments, the pressure adjustment switch 182 is a switch configured to be used to switch the output of the motor 44. The information displayed on the pressure display 270 (an example of “display”) includes information that changes according to an operation by a user on the pressure adjustment switch 182.

According to the above configuration, the user can operate the pressure adjustment switch 182 while looking at the information that changes according to the operation performed on the pressure adjustment switch 182. Thus, user convenience can be improved.

In one or more embodiments, the backpack type sprayer 2 comprises the body unit 4, the motor 44 housed in the body unit 4, the right shoulder belt 72 attached to the body unit 4 and configured to be worn on the shoulder of the user, the display unit 260 configured to display information related to the output of the motor 44, and the right triglide 86 (an example of “attachment portion”) configured to attach the display unit 260 to the right shoulder belt 72. The position of the display unit 260 on the right shoulder belt 72 is configured adjustable.

It is desirable for a user to be able to see information related to the output of the motor 44 when using the backpack type sprayer. In the above configuration, the display unit 260 can be attached to the right shoulder belt 72 and the position of the display unit 260 on the right shoulder belt 72 is configured adjustable. This allows the user to position the display unit 260 on the front side of the user's body. The user can also adjust the position of the display unit 260 on the right shoulder belt 72 to a position that is easily visible to the user. Thus, the user can see information related to the output of the motor 44 when using the backpack type sprayer. Thus, convenience for the user using the backpack type sprayer can be improved.

In one or more embodiments, the information related to the output of the motor 44 may be the spray pressure.

In sprayers, a spray pressure is important. According to the above configuration, the user can easily check the spray pressure, which is important information.

(First Variation) The “working machine” is not limited to a sprayer, but may also be a dust collector, a blower, or a mist blower, for example.

(Second Variation) The sprayer 2 of the first embodiment may comprise a plurality of attachment portions configured to attach the switch unit 160 to the right shoulder belt 72. In this variation, the plurality of attachment portions may be fixed to the right shoulder pad 80. The plurality of attachment portions may be aligned in a direction in which the right shoulder pad 80 extends. In this variation, the user can adjust the position of the switch unit 160 on the right shoulder belt 72 by changing the attachment portion to which the switch unit 160 is attached. The sprayer of the second embodiment may also comprise a plurality of attachment portions configured to attach the display unit 260 to the right shoulder belt 72.

(Third Variation) In each of the above embodiments, the switch unit 160 and the display unit 260 are configured to be attached to the right shoulder belt 72. The switch unit 160 and the display unit 260 may be configured to be attached to the left shoulder belt 74.

(Fourth Variation) The maximum static friction force between the right triglide 86 and the right shoulder belt 72 (the first belt 82 in particular) under the state where the switch unit 160 is not attached to the right shoulder belt 72 and the maximum static friction force between the right triglide 86 and the right shoulder belt 72 (the first belt 82 in particular) under the state where the switch unit 160 is attached to the right shoulder belt 72 may be the same as each other.

(Fifth Variation) In the first and second embodiments, the lower housing 180 may be disposed along a plane including the first and second directions. That is, the angle A1 between the first back surface 168B of the upper housing 168 and the second back surface 180B of the lower housing 180 in the first embodiment may be 180°. The same applies to the angle between the back surface of the upper housing 268 and the second back surface 180B of the lower housing 180 in the second embodiment.

(Sixth Variation) The switch unit 160 of the first embodiment simply needs to comprise at least one of the main power switch 170A, the remaining capacity indicator switch 170B, and the pressure adjustment switch 182.

(Seventh Variation) The display unit 260 of the second embodiment may not comprise the pressure adjustment switch 182.

What is claimed is:

1. A backpack type working machine comprising:
a body unit;
a motor housed in the body unit;
a shoulder belt attached to the body unit and configured to be worn on a shoulder of a user;
an operation unit configured to be used to switch a state of the motor; and
a first attachment portion configured to attach the operation unit to the shoulder belt,
wherein a position of the operation unit on the shoulder belt is configured adjustable.

2. The backpack type working machine as in claim 1, wherein the first attachment portion is configured movable on the shoulder belt,
a maximum static friction force between the first attachment portion and the shoulder belt under a state where the operation unit is attached to the first attachment portion is larger than a maximum static friction force between the first attachment portion and the shoulder belt under a state where the operation unit is not attached to the first attachment portion.

3. The backpack type working machine as in claim 1, wherein the operation unit comprises:
a first operation portion disposed along a first plane including a first direction and a second direction perpendicular to the first direction; and
a second operation portion connected to an end in the first direction of the first operation portion and disposed along a second plane including a third direction and the second direction, the third direction being a direction inclined relative to the first direction; and
when the operation unit is seen along the second direction, an angle between a back surface of the first operation portion and a back surface of the second operation portion is an obtuse angle.

4. The backpack type working machine as in claim 3, wherein under the state where the operation unit is attached to the first attachment portion, the first operation portion is disposed above the second operation portion,
wherein a display is disposed on a front surface side of the first operation portion, and
a dial-type switch that protrudes from a front surface of the second operation portion is disposed on the front surface side of the second operation portion.

5. The backpack type working machine as in claim 4, wherein the dial-type switch is a switch configured to be used to change an output of the motor, and
information displayed on the display includes information that changes according to an operation performed by the user on the dial-type switch.

6. The backpack type working machine as in claim 1, further comprising:
a waist belt attached to the body unit and configured to be worn on a waist of the user; and
a second attachment portion configured to attach the operation unit to the waist belt.

7. A backpack type working machine comprising:
a body unit;
a motor housed in the body unit;
a shoulder belt attached to the body unit and configured to be worn on a shoulder of a user;
a display unit configured to display information related to an output of the motor; and
an attachment portion configured to attach the display unit to the shoulder belt,
wherein a position of the display unit on the shoulder belt is configured adjustable.

8. The backpack type working machine as in claim 7, wherein the working machine is a sprayer, and
the information related to the output of the motor is a spray pressure.

9. The backpack type working machine as in claim 2, wherein the operation unit comprises:
a first operation portion disposed along a first plane including a first direction and a second direction perpendicular to the first direction; and
a second operation portion connected to an end in the first direction of the first operation portion and disposed along a second plane including a third direction and the second direction, the third direction being a direction inclined relative to the first direction; and
when the operation unit is seen along the second direction, an angle between a back surface of the first operation portion and a back surface of the second operation portion is an obtuse angle,
wherein under the state where the operation unit is attached to the first attachment portion, the first operation portion is disposed above the second operation portion,
wherein a display is disposed on a front surface side of the first operation portion, and
a dial-type switch that protrudes from a front surface of the second operation portion is disposed on the front surface side of the second operation portion,
wherein the dial-type switch is a switch configured to be used to change an output of the motor, and
information displayed on the display includes information that changes according to an operation performed by the user on the dial-type switch,
wherein the backpack type working machine further comprises:
a waist belt attached to the body unit and configured to be worn on a waist of the user; and
a second attachment portion configured to attach the operation unit to the waist belt,
wherein the working machine is a sprayer, and
the information displayed on the display includes a spray pressure.
